(19) United States
(12) Patent Application Publication
(10) Pub. No.: US 2007/0267584 A1
(43) Pub. Date: Nov. 22, 2007

(54) Optical code reader using an anamorphic Scheimpflug optical system

(75) Inventor: Craig D. Cherry, Eugene, OR (US)

Correspondence Address: DATALOGIC - STOEL RIVES LLP;C/O STOEL RIVES LLP, 900 SW 5TH AVENUE, SUITE 2600, PORTLAND, OR, 97204, US

(73) Assignee: PSC Scanning, Inc., Eugene, OR (US)

(21) Appl. No.: 11/437,377

(22) Filed: May 19, 2006

(51) Int. Cl. G06K 7/10

(52) U.S. Cl. 250/555

(57) ABSTRACT

Systems and methods for optical code reading are disclosed. In one system optical code reader includes an anamorphic lens system and an image sensor array, wherein the image sensor array is tilted with respect to the anamorphic lens system according to the Scheimpflug principle.

### BACKGROUND

The field of the present disclosure relates generally to optical code readers using Scheimpflug optics. Optical code systems, including for example bar code systems, have come into wide use for marking a great variety of objects for automatic reading. Optical codes are used commercially in many applications, including the identification of retail products at the point of sale, control of inventories, and package identification.

Optical codes include, but are not limited to, a series of light and dark areas of varying widths and heights. The simplest of optical codes are often commonly referred to as one-dimensional (hereinafter 1D), such as the UPC code, and two-dimensional (hereinafter 2D) codes, such as PDF417 and Maxicode. However, other configurations of light and dark areas may also represent optical codes. An example of such a configuration may be symbolic codes, such as a light and dark areas configured in the shape of a lightning bolt to represent electricity. Light and dark areas configured in the shape of alphanumeric text may also be read as an optical code.

Many conventional optical code readers suffer from shallow Depth of Field (DOF). Due to the shallow DOF, optical codes remain in focus over a narrow range of distances.

### BRIEF DESCRIPTION OF THE DRAWINGS

FIG. 1 is a three dimensional diagram of an anamorphic optical system.

FIG. 2 is a three dimensional diagram of an imaging system using an anamorphic lens system and the Scheimpflug condition.

FIG. 3 is a diagram of an imaging system using an alternative embodiment of an anamorphic lens system and the Scheimpflug condition.

FIG. 3A is a top view of the anamorphic lens system of the imaging system of FIG. 3.

FIG. 4 is a three dimensional diagram of an imaging system using an anamorphic lens system and the Scheimpflug condition.

FIG. 5 is a diagram of an image sensor array used in an optical code reader.

FIG. 6 is a diagram of an alternative arrangement of an imaging system utilizing the Scheimpflug condition and having multiple sensors, each having its own anamorphic lens system and sharing a common beam splitter.

FIG. 7 is a flow diagram of one embodiment of a method for reading an optical code.

### DETAILED DESCRIPTION

It will be readily understood that the components of the embodiments as generally described and illustrated in the figures herein could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The order of the steps or actions of the methods described in connection with the embodiments disclosed herein may be changed by those skilled in the art. Thus, any order in the figures or detailed description is for illustrative purposes only and is not meant to imply a required order.

An optical code reader detects reflected and/or refracted light from an optical code comprising various optical characters or elements. One method of illuminating the optical code is via a scanning laser beam. In this method a beam of light is swept across the optical code and an optical detector detects the reflected light. Typically, the detector generates an electrical signal having amplitude proportional to the intensity of the collected light.

An alternative method for illuminating an optical code is accomplished by using a uniform light source with the reflected light detected by a one dimensional or two dimensional sensor array, such as a charge-coupled device (CCD) or CMOS image sensor. In such a technique, as with a scanning laser, an electrical signal is generated having an amplitude determined by the intensity of the collected light. In some embodiments using either the scanning laser or imaging technique, the amplitude of the electrical signal has one level for the dark areas of the optical code and a second level for the light areas of the optical code. As the code is read, positive-going and negative-going transitions in the electrical signal occur, signifying transitions between light and dark areas.

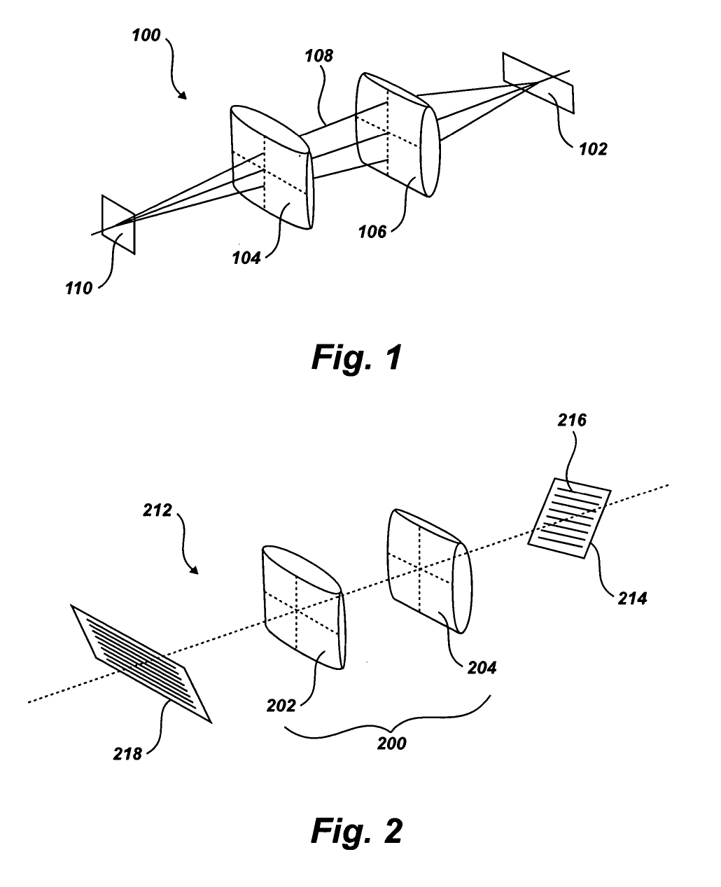

FIG. 1 illustrates an anamorphic optical system 100 according to a first embodiment. An anamorphic optical system is a lens system that has a different power or magnification in one principal meridian than in the other. An anamorphic system may use cylindrical surface lenses or prisms to produce the different magnification in different directions in an image plane 102. For instance, in the embodiment depicted in FIG. 1, the anamorphic optical system 100 comprises first 104 and second 106 cylindrical surface lenses. The first cylindrical surface lens 104 is similar to a plane parallel plate for the ray lines 108 depicted. A plane parallel plate typically displaces, but does not deviate a ray 108 passing there through, i.e., the input and output rays are parallel. However, the second cylindrical surface lens 106 refracts these rays 108 similarly as a spherical lens would, because the cylinder axes are orthogonal to the first cylindrical surface lens 104.

By way of example, the magnification of the fan of rays 108 depicted is 0.5×. However, with a fan of rays in the other prime meridian (not shown), the magnification effect is reversed. The lens effect occurs at the first cylindrical surface lens 104 instead of the second 106 and the magnification is greater, such as, for example 2.0×. Thus, the square object 110 has a corresponding rectangular image 102 with a length four times its width.

Alternative anamorphic lens systems may be used as would be apparent to those having skill in the art with the aid of the present disclosure. One exemplary alternative involves using a spherical objective lens combined with a Galilean telescope composed of cylinder lenses. Another alternative anamorphic system may include a Bravais system using cylindrical optics. Yet another alternative is using one or more refracting prisms to achieve an anamorphic effect.

FIG. 2 illustrates an imaging system 212 using an anamorphic lens system 200. The imaging system 212 may include a detector, such as a sensor array 214. The sensor array 214 may be tilted at an angle with respect to the lens system 200 (or lens system 200 with respect to the sensor array 214), such that the sensor array 214 is non-parallel with the lens system 200 (i.e., the image plane is non-parallel with the lens plane), according to the Scheimpflug principle. The lens system 200 may comprise a first cylindrical surface lens 202 and a second cylindrical surface lens 204.

Conventional optical code readers typically have a sensor array aligned generally parallel with its corresponding lens system (i.e., the image plane and lens plane are both parallel to each other and both perpendicular to the optical axis). These conventional readers may be limited in their depth of field (“DOF”), sometimes referred to as the working or reading range. To accurately read objects marked with an optical code, the optical code must typically lie within a particular range of distances before the fixed focal lens distance. The particular range of distances before the fixed focal lens distance is known as the DOF. Thus, unless the entirety of the optical code lies within the shallow DOF of a conventional optical code reader, most of the optical code image produced on the image sensor array may be out of focus and may not be accurately read.

The DOF of an optical code reading system varies as a function of, among other variables, focal distance and aperture setting. Conventional optical code readers typically suffer from a shallow DOF. This shallow DOF is due to the low levels of reflected light available to read an optical code, particularly in ambient light CCD optical code readers. Since low levels of light are available, the optical code reader system requires the use of large aperture settings. This large aperture setting in turn results in a shallow DOF. While a conventional optical code reader may accurately read an optical code at the exact focal distance of the system, slight variations from this focal distance (i.e., outside the DOF) will result in out-of-focus and sometimes unsuccessful reading of the optical code.

One method used to partially counteract this shortcoming is to raise the f-number of the optical system. Unfortunately, when the f-number is increased the corresponding aperture size decreases. As a result, the amount of light passed through the optical system also decreases. This decreased light is particularly evident in an imaging-type optical code reader. The reduced available light level requires that the time for integration of the optical code image on the sensor must be increased, or extra illumination must be provided on the optical code, or both. If longer integration time is used, the sensitivity to image blur due to optical code image motion may be increased. If extra illumination is required, then the cost, complexity, and power requirements of such a system may also be increased.

In the embodiment depicted in FIG. 2, tilting the sensor array 214 with respect to the lens system 200 according to the Scheimpflug principle increases the DOF without increasing the f-number. Consequently, the aperture size is not decreased and adequate light is allowed through the system 212. The use of an anamorphic lens system 200 in combination with the Scheimpflug condition allows the field angle (and reading line length) to be optimized separately from the reading range.

The image sensor array 214 includes a pattern of horizontal raster lines 216. The image sensor array 214 produces a projected image 218 in object space. The object space is the space in which a physical object, such as an optical code can be read. The image space is the space in which an image of a physical object, such as an optical code, is produced by the lens system 200.

Instead of visualizing the image of an object produced in image space, FIG. 2 illustrates a projected image 218 of an image sensor array 214 into object space. The image sensor array 214 is a physical object upon which an image through the lens system 200 may be produced. However, an “image” 218 of the image sensor array 214 may be projected to the other side of the lens system 200 (i.e., object space). The projected image 218 represents the area in object space where an optical code (not shown) may be positioned to produce a well focused image of the code through lens system 200 onto an image sensor array 214.

The projected image 218 of the image sensor array 214 is oriented to read optical code labels, such as 1D optical codes, having optical code elements oriented in a substantially vertical direction (i.e., perpendicular to the horizontal raster lines). In one embodiment, the anamorphic lens system 200 increases the magnification of the projected image 218 of the sensor array 214 in a horizontal direction, i.e., in a direction parallel to a scan line direction of the optical code reader or in a plane parallel to the pattern of horizontal raster lines 216. The path of the reading spot created on an object by a moving illumination beam is referred to as a scan line. Typically, an individual scan line extends across and substantially perpendicular to the bar elements for an optical code to be successfully read.

Because the anamorphic lens system 200 expands the projected image 218 horizontally (compared to the horizontal dimension of the sensor array 214), the imaging system 212 is capable of reading an entire code that is placed closer to the reader and also provides for a sufficient resolution of an optical code that is read further away from the reader.

In an alternative embodiment, the magnification of the projected image 218 may be decreased horizontally (relative to vertical magnification). For example, if the pixel spacing of the image sensor array 214 results in insufficient pixel density to accurately read the narrow elements of an optical code at the furthest desired reading distance, the magnification in the horizontal direction may be decreased relative to vertical magnification. However, if it is desirable to read optical codes at a close range, the magnification in the horizontal direction may be increased relative to the vertical magnification, such that the raster line may traverse the entire code. The appropriate value of magnification in the horizontal direction may depend on the number of pixels available on a raster line and the pixel spacing of the image sensor array 214.

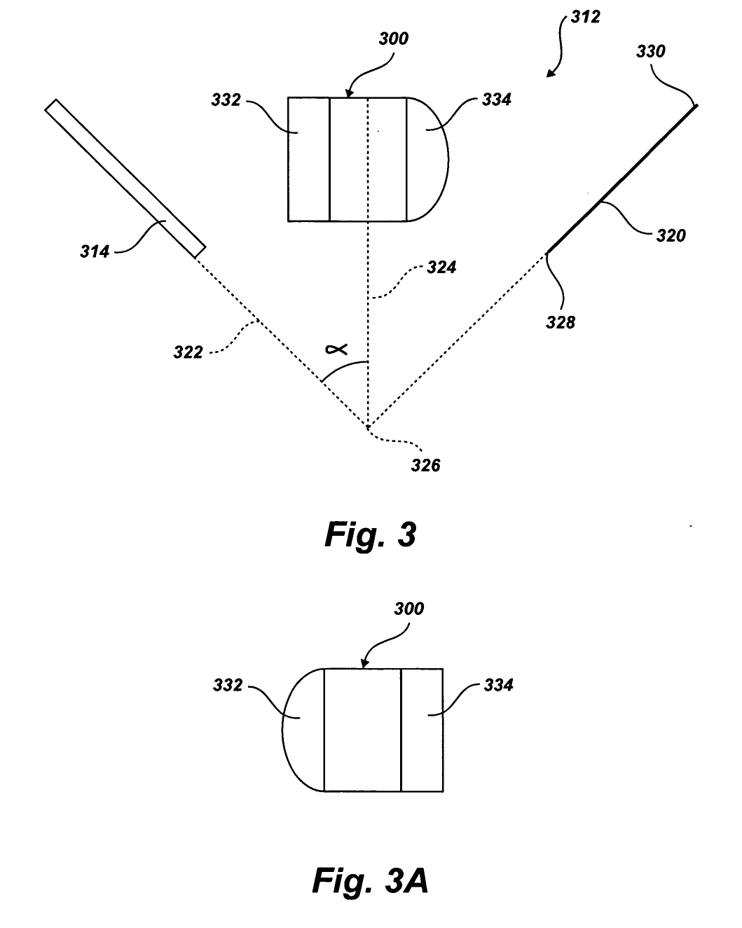

FIG. 3 illustrates an alternative embodiment of an imaging system 312 using an anamorphic lens system 300 and the Scheimpflug condition. By tilting an image sensor array 314 by some angle α, the corresponding object plane 320 will also be tilted according to the Scheimpflug condition. All points on the object plane 320 will be in focus on the image sensor array 314. As shown in FIG. 3, the image sensor array plane 322 has been tilted at an angle α with respect to the lens plane 324 such that the object plane 320, image sensor array plane 322 and lens plane 324 intersect at the Scheimpflug point 326. Depending on the relative orientation of the object plane 320, the angle α, measured between the image sensor plane 322 and lens plane 324, may vary. In one embodiment, the angle α may be greater than 0° but less than 90°. Alternatively, the angle α may be greater than 90° but less than 180°.

When an optical code (not shown) intersects the object plane 320, the line of intersection formed between the optical code plane and the object plane 320 will be in focus on the image sensor array 314, provided the optical code intersects within the DOF. The DOF is the distance between the inner DOF limit 328 and the outer DOF limit 330 along the object plane 320 as measured along the optical axis. This DOF is not dependent upon the aperture size, and thus the aperture may be fully opened allowing maximum image brightness.

Alternatively, the lens plane 324 may be tilted relative to the sensor array plane 322, and, once again, in accordance with the Scheimpflug principle, the object plane 320, image sensor array plane 322, and lens plane 324 will intersect at the Scheimpflug point 326.

According to the embodiment of FIG. 3, the anamorphic lens system 300 includes two crossed, non-circular, cylindrical surfaces 332, 334. The diagram of FIG. 3 shows the anamorphic system 300 from a side view. The diagram of FIG. 3A shows the anamorphic system 300 from a top view. The near cylindrical surface 332 is oriented at 90° with respect to the far cylindrical surface 334. Rather than being circularly symmetric, the magnification of the anamorphic system 300 varies with orientation around the optical axis.

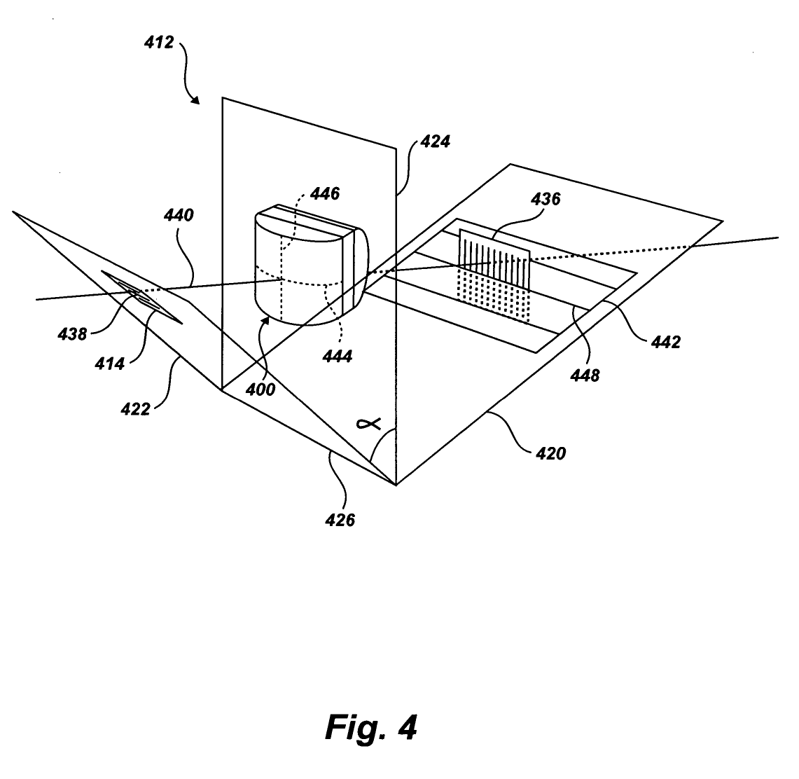

FIG. 4 represents an imaging system 412 using an anamorphic lens system 400 depicted from a three-dimensional view. The imaging system 412 utilizes a Scheimpflug arrangement for achieving large depths-of-field at low f-numbers for reading an optical code 436 using a tilted imaging array 414. The array 414 depicted is a two-dimensional array of photodetectors as is typically employed in a CCD, CMOS, or other imaging sensor. The imaging array 414 may comprise many rows of photodetectors 438.

As can be seen from FIG. 4, the imaging array 414 has been tilted in one direction about the optical axis 440. The tilt angle α, lens focal length, aperture setting, and imaging array resolution may be selected to obtain the desired characteristics of depth-of-field and scan line width at a certain distance from the lens system 400. When the imaging array 414 is tilted, the corresponding object plane 420 on the opposite side of the lens system 400 also tilts according to the Scheimpflug condition, whereby the sensor plane 422, the lens system plane 424, and the object plane 420 all intersect along a common line 426.

Rectangle 442 represents the projection of the image sensor array 414 through the lens system 400 onto the object plane 420. The projection 442 of the image sensor 414 is rectangular because the magnification in the horizontal axis 444 is greater than the vertical axis 446 through the anamorphic lens system 400. The row of photodetectors 438 of the sensor array 414 have corresponding projected raster lines 448 in the rectangular sensor array projection 442. An optical code 436 will be in focus on the line of photodetectors 438 when it intersects the corresponding projected raster line 448, as shown.

In order to utilize the most depth-of-field, the optical code 436 may be oriented as shown, generally normal to the optical axis 440. When a 1D optical code 436 in the position shown is imaged, the sharpest region of focus on the sensor array 414 will be centered around the row of photodetectors 438 that corresponds to the line of intersection 448 between the optical code plane 420 and the projection of the image sensor array 442. Because there may be some finite depth-of-field inherent in the lens system 400, there will typically be several rows of detectors in focus above and below the specific row conjugate to the line of intersection 448 between the optical code 436 and the projection of the sensor 442. However, there may be gradually increasing amounts of defocus further above or below the row of photodetectors 438 conjugate to the line of intersection 448.

If the inherent depth-of-field of the lens system 400 is sufficient, there may be enough photodetector rows 438 in focus in order to image a “stacked” or two-dimensional optical code. However, producing a focused image of only a portion of the 2D code may not be sufficient to fully read the optical code.

In a Scheimpflug system using conventional, circularly symmetrical optics, the focal length of the lens is related to the Scheimpflug angle α of the image sensor array 414 required to achieve a particular range of raster line focal distances. The focal length of the lens is also related to the length of the raster lines in the object space. However, an anamorphic lens system 400 provides an additional degree of freedom in the system design, allowing the imager Scheimpflug angle α to be optimized separately from the choice of raster line length versus distance (corresponding to the imager angle of view in the axis parallel to the raster lines).

Inputs for an imaging system 412 design may include the near object distance limit, the far object distance limit, and the minimum required reading line length at the near distance. The designer of the imaging system 412 may choose from the available image sensors, having some particular dimensions, and determine the position of the sensor and lens, and the focal length of the lens. The lens focal length in one axis determines the location of the near and far reading limits relative to the lens 400 and image sensor array 414. The lens focal length in the perpendicular axis determines the reading line length versus distance (a function of the field angle in a plane parallel to the raster lines). By allowing these two focal lengths to differ, as in an anamorphic system 400, the designer has more flexibility to meet what could otherwise be contradictory design goals.

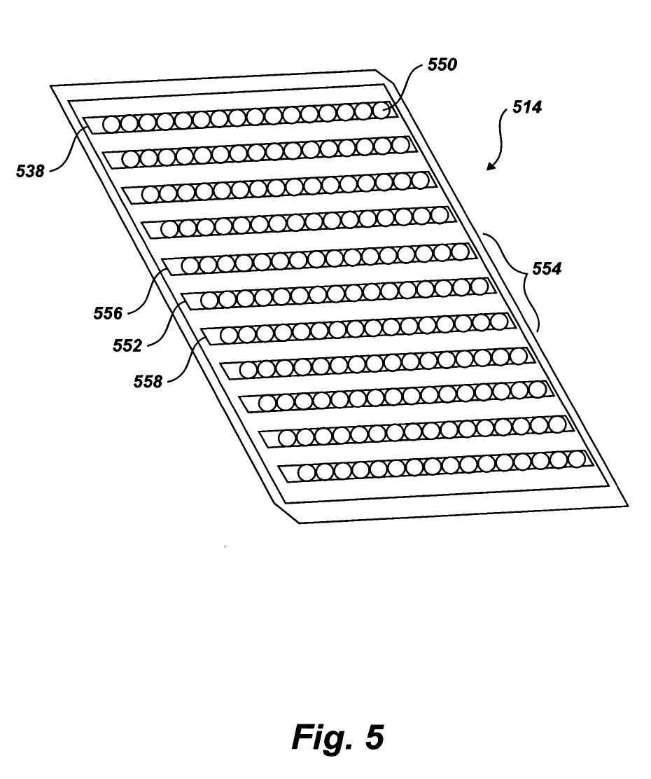

FIG. 5 illustrates a simplified view of the face of image sensor array 514 used in an optical code reader. The image sensor array 514 may be made up of a series of video sensing (or raster) lines 538. Each video sensing (or raster) line 538 is made up of smaller individual pixels 550 which are capable of sensing photons of light collected through a lens system (not shown). These lines 538 may be oriented in either a horizontal or vertical direction. In FIG. 5, the video lines 538 are depicted in a horizontal orientation.

For the image sensor array 514 to be oriented to read an optical code, such as a bar code symbol, the video lines 538 are positioned in a direction substantially perpendicular to the direction of the bars in the optical code. Considering, as an example, a simple 1D bar code, information is encoded as a series of vertically oriented bars of varying widths. Each bar of varying width represents a piece of encoded data. In order to read all of the data encoded on the optical code label, sufficient video lines, such as line 538, collect data across the entire horizontal axis of the optical code label, either all in one line, or in sufficiently usable pieces.

The amount of perpendicular alignment of the raster lines 538 with the optical code depends on the vertical extent of the optical code's edges and the size of the sections that may be successfully “stitched” or merged together by the signal processing or decoding system. Put another way, the amount of orientation manipulation of the raster pattern depends on the actual dimensions of the optical code label and the stitching capabilities of the system. For example, an “oversquare” optical code label (i.e., an optical code label that has a height dimension slightly greater than the width dimension of the smallest usable piece, which is often half of the entire label) may be rotated up to 45 degrees from its vertical alignment and still be accurately read by a horizontal raster pattern. An oversquare optical code label oriented in a direction rotated up to 45 degrees from vertical may still permit at least one horizontal video line 538 of the raster pattern to register a complete cross section of the optical code (i.e., corner-to-corner) usable piece.

On the other hand, truncated optical code labels may be used to conserve space. Truncated optical code labels are labels that are shorter in their vertical bar dimension than their horizontal dimension. Use of a truncated optical code often requires a greater degree of proper orientation with the optical code reader. As a truncated optical code label is rotated beyond a predetermined angle, horizontal video lines 538 are no longer able to produce complete cross sectional images of the truncated optical code label. As truncated optical code labels become shorter, the angle of rotation permitted for proper orientation is reduced.

As shown in FIG. 5, video line 552 represents the video line that corresponds to the line of the object (optical code) that intersects the object plane (see FIG. 4). As was discussed previously, several raster lines 538 may be in focus above and below the specific line 552 conjugate to the line of intersection between the optical code and the projection of the sensor array 514. In the example depicted in FIG. 5, the focused image portion of the sensor array 514 lies in the region 554, made up of video lines 552, 556 and 558. The number of raster lines 538 included in the focused image portion 554 may be dependent on the resolution or spacing of the raster lines 538.

An anamorphic lens system used in conjunction with the Scheimpflug condition provides adequate resolution for bar code elements that are positioned a distance away from the code reader. In some embodiments, 1.5 pixels corresponding to each element of the bar code may be sufficient to provide adequate resolution.

Additionally, when the optical code is positioned close to the reader, pixel density does not typically pose a problem since there are usually plenty of pixels per each optical code element. However, sometimes the entire length of the optical code cannot all fit onto the sensor array 514. Since magnification about the optical axis varies in an anamorphic lens system, an anamorphic system helps to fit the horizontal dimension of an image of the entire optical code on the sensor array 514 when the optical code is positioned close to the reader.

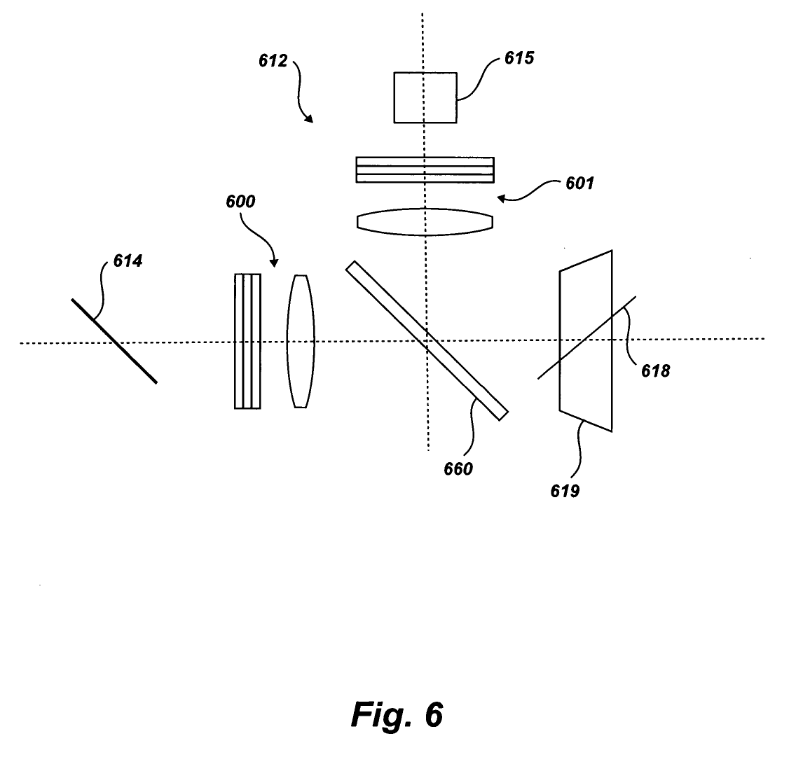

FIG. 6 illustrates an imaging system 612 having two image sensor arrays 614 and 615. Each image sensor array 614 and 615 is arranged at an angle with respect to its corresponding anamorphic lens system 600, 601 in accordance with the Scheimpflug principle so that the DOF of each image sensor array 614, 615 is improved. In one embodiment, the tilt angle of each image sensor array 614, 615 are equivalent. In another embodiment, the first and second tilt angles of each image sensor array 614, 615 (respectively), are not equivalent. Each image sensor array 614, 615 produces respective projected images 618 and 619 in object space. In one embodiment, the image planes of the projected images 618, 619 are orthogonal to each other.

These projected images 618 and 619 represent the region in object space where an object (not shown) will produce a well-focused image and also represent the relative orientation of an optical code which may be positioned at and still be accurately read. As additional raster patterns are added to the optical code reader system 612, the probability that the orientation of an added raster pattern is substantially perpendicular to the orientation of the optical code increases.

According to the embodiment depicted in FIG. 6, the imaging system 612 includes a beam splitter 660. In this configuration, the image of the first image sensor array 614 is created by the direct optical path from the image sensor array 614, through the first anamorphic lens system 600 and the partially transmissive beam splitter 660 to the projected sensor image 618. The second image sensor array 615 produces an image 619 from rays of light following the optical path through the second anamorphic lens system 601, and reflected by the beam splitter 660, to projected image 619.

This construction allows for a compact scan zone, which may be easier for an operator to use. Thus, an object (positioned in object space) marked with an optical code label with either a substantially vertical or horizontal orientation positioned within the scan zone will likely produce a well-focused, fully-read image of the optical code label on the image sensors 614, 615 in image space.

Referring still to FIG. 6, an object marked with an optical code label may be read when oriented substantially in either the vertical direction or the horizontal direction in object space. Additionally, for “oversquare” optical codes, any object marked with an optical code label rotated up to 45 degrees from either the horizontal or vertical axis and located within the scan zone in object space, may be read. Thus, for an object marked with an “oversquare” optical code label, the optical code label oriented in virtually any direction may be read. In the more common truncated optical code situation however, two imaging sensors orthogonal to one another will increase the possible orientation directions that may be read but may not necessarily allow for omni-directional reading. Additional imaging sensor arrays and other suitable methods may be utilized to provide omni-directional reading of truncated optical codes.

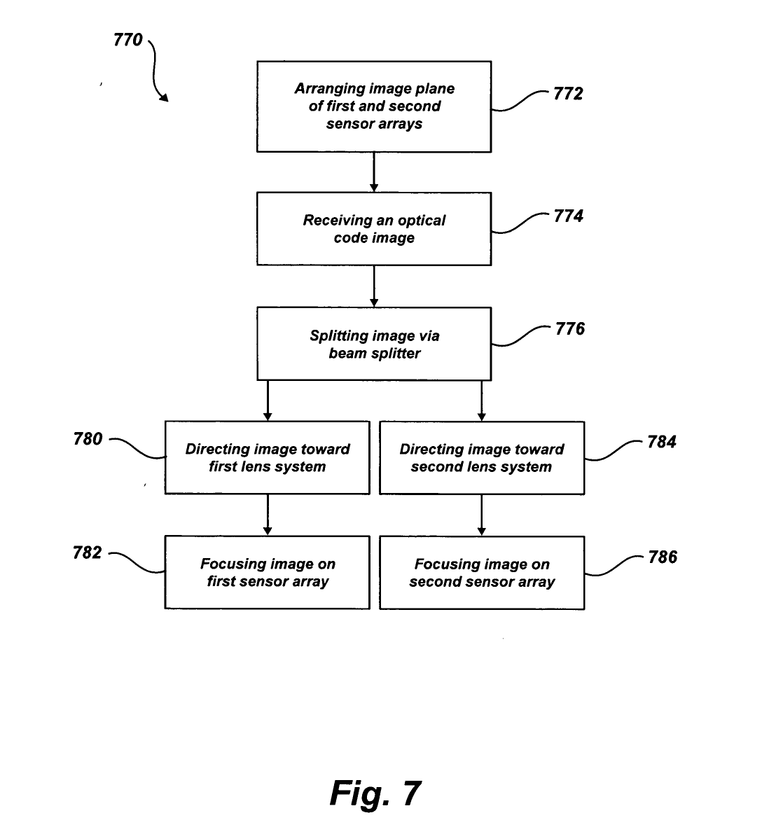

FIG. 7 represents one embodiment of a method 770 for reading an optical code using an anamorphic lens system and the Scheimpflug condition. According to one embodiment, the method 770 for reading an optical code is done with a single sensor array and anamorphic lens system. Alternatively, in another embodiment of a method 770 for reading an optical code, multiple image sensor arrays and corresponding anamorphic lens systems may be employed.

In an embodiment having two image sensor arrays, the method 770 includes arranging at step 772 the image planes of the first and second sensor arrays so that they are perpendicular to each other. The step of arranging the image planes to be perpendicular with each other may increase the likelihood of successfully reading a randomly positioned optical code. The step 772 of arranging the image planes may also include positioning the projected images of the sensor arrays so that at least one sensor array's raster lines are positioned substantially orthogonal to the optical code.

The method 770 for reading an optical code may further include the reader receiving at step 774 an image of an optical code produced when light is reflected off of the optical code when illuminated. The step 774 of receiving the optical code image may comprise capturing the reflected image by the reader and introduction of the optical code image to the optical train. The optical code image may be split at step 776 using a beam splitter or other suitable method of splitting as would be apparent to those having skill in the art with the aid of the present disclosure.

A portion of the reflected optical image may be transmitted through the partially transmissive beam splitter and directed at step 780 to a first anamorphic lens system. The first anamorphic lens system may then focus at step 782 the optical code image onto the first sensor array. The first sensor array may be tilted with respect to the anamorphic lens system in accordance with the Scheimpflug principle.

According to the method 770 described in conjunction with FIG. 7, a portion of the optical code image is reflected by the partially transmissive beam splitter and directed at step 784 toward a second anamorphic lens system. Like the first anamorphic lens system, the second anamorphic lens system focuses at step 786 the optical code image onto the second image sensor array while providing a non-uniform magnification about the optical axis.

In alternative embodiments, the optical code image may not be split via a beam splitter but directed at step 780 solely toward the first lens system and focused at step 782 on the first sensor array. These alternative embodiments may not necessarily include a second sensor array and accompanying beam splitter.

While specific embodiments of various optical imaging systems and related methods have been illustrated and described, it is to be understood that the invention claimed hereinafter is not limited to the precise configuration and components disclosed. Various modifications, changes, and variations apparent to those of skill in the art with the aid of the present disclosure may be made in the arrangement, operation, and details of the methods and systems disclosed.

Furthermore, the methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified without departing from the scope of the invention as claimed.

What is claimed is:

1. An optical code reader, comprising:
a first anamorphic lens system; and
a first image sensor array for detecting a signal representative of light reflected from an optical code through the first anamorphic lens system;
wherein the first image sensor array is disposed at a first tilt angle with respect to the first anamorphic lens system according to the Scheimpflug principle, and the first anamorphic lens system adjusts a magnification of a projected image of the first image sensor array in a direction parallel to a scan line direction of the optical code reader.

2. The optical code reader of claim 1, wherein the first image sensor array includes horizontal raster lines and the first anamorphic lens system adjusts the magnification of the projected image of the first sensor array in a plane parallel to the raster lines.

3. The optical code reader of claim 1, wherein the first anamorphic lens system increases the magnification of the projected image of the first image sensor array in the direction parallel to the scan line direction of the optical code reader.

4. The optical code reader of claim 1, wherein the first anamorphic lens system comprises a first cylindrical surface lens and a second cylindrical surface lens, such that cylinder axes of the first cylindrical surface lens are oriented orthogonally about an optical axis relative to cylinder axes of the second cylindrical surface lens.

5. The optical code reader of claim 1, wherein the first image sensor array comprises a two-dimensional array.

6. The optical code reader of claim 1, further comprising:
a second anamorphic lens system; and
a second image sensor array for detecting a signal representative of light reflected from the optical code through the second anamorphic lens system;
wherein the second image sensor array is disposed at a second tilt angle with respect to the second anamorphic lens system according to the Scheimpflug principle.

7. The optical code reader of claim 6, further comprising:
a beam splitter to provide a reflected image of the optical code to the first image sensor array and a transmissive image of the optical code to the second image sensor array.

8. The optical code reader of claim 6, wherein an image plane of the first sensor array is orthogonal to an image plane of the second sensor array.

9. An optical code reader, comprising:
a lens system having a magnification that varies around an optical axis of the lens system;
an image sensor array for detecting a signal representative of light reflected from an optical code through the lens system;
wherein the image sensor array is disposed at a tilt angle α with respect to the lens system according to the Scheimpflug principle and the lens system adjusts a magnification of a projected image of the image sensor array in a direction parallel to a scan line direction of the optical code reader.

10. The optical code reader of claim 9, wherein the lens system comprises a first cylindrical surface lens and a second cylindrical surface lens, such that cylinder axes of the first cylindrical surface lens are oriented orthogonally about an optical axis relative to cylinder axes of the second cylindrical surface lens.

11. The optical code reader of claim 10, wherein the lens system is an anamorphic lens system.

12. An optical code reader, comprising:
a beam splitter for directing return light reflected from an optical code along two collection paths including a first collection path and a second collection path;
a first anamorphic lens system disposed in the first collection path;
a first image sensor array for detecting a signal representative of light reflected from an optical code through the first anamorphic lens system, such that the first image sensor array is disposed at a first tilt angle with respect to the first anamorphic lens system;
a second anamorphic lens system disposed in the second collection path; and
a second image sensor array for detecting a signal representative of light reflected from the optical code through the second anamorphic lens system, such that the second image sensor array is disposed at a second tilt angle with respect to the second anamorphic lens system and oriented in a direction substantially orthogonal to the first image sensor array.

13. The optical code reader of claim 12, wherein the first and second anamorphic lens systems each comprise a first cylindrical surface lens and a second cylindrical surface lens, such that cylinder axes of the first cylindrical surface lens are oriented orthogonally about an optical axis relative to cylinder axes of the second cylindrical surface lens.

14. The optical code reader of claim 12, wherein the first tilt angle is equivalent to the second tilt angle.

15. The optical code reader of claim 12, wherein the first tilt angle is different from the second tilt angle.

16. A method of reading an optical code, comprising:
receiving an image of an optical code to be read;
directing the image toward a first anamorphic lens system; and
focusing the image with the first anamorphic lens system onto a first sensor array, the first sensor array being arranged at a first tilt angle with respect to the first anamorphic lens system according to the Scheimpflug principle.

17. The method of claim 16, further comprising:
directing the image toward a second anamorphic lens system; and
focusing the image with the second anamorphic lens system onto a second sensor array, the second sensor array being arranged at a second tilt angle with respect to the second anamorphic lens system according to the Scheimpflug principle.

18. The method of claim 17, wherein directing the image toward the first and second anamorphic lens systems comprises splitting the image for simultaneously directing the image toward the first and second anamorphic lens systems.

19. The method of claim 18, wherein splitting the image comprises splitting the image via a beam splitter.

20. The method of claim 17, further comprising:
arranging an image plane of the first sensor array orthogonal to an image plane of the second sensor array.
